(19) United States
(12) Patent Application Publication
(10) Pub. No.: US 2009/0051161 A1
(43) Pub. Date: Feb. 26, 2009

(54) Multiconnector For a Conduit

(75) Inventor: Jorgen Ekstrom, Skovde (SE)

Correspondence Address: BIRCH STEWART KOLASCH & BIRCH, PO BOX 747, FALLS CHURCH, VA, 22040-0747, US

(73) Assignee: Bo Erik NYBERG, Oberageri (CH)

(21) Appl. No.: 12/087,999

(22) PCT Filed: Jan. 31, 2007
(86) PCT No.: PCT/SE2007/050046

§ 371 Date: Nov. 6, 2008

(30) Foreign Application Priority Data
Feb. 1, 2006 (SE) 0600207-5

(51) Int. Cl. F16L 39/02

(52) U.S. Cl. 285/29

(57) ABSTRACT

Multiconnector for hoses (9) or the like for media under pressure, comprising a first and a second connection element (3′, 3″); the multiconnector (1) comprises first and second male parts (21′, 21″) and first and second female parts (23′, 23″); one of the connection elements (3′) comprises a female part (23′) that comprises a locking sleeve (17), that is spring-loaded towards a locked position, in which position the locking sleeve (17) holds a ball catch (52) in an engaged position for locking the male part (21′) in the female part (23′) in a connected position; the locking sleeve (17) can be moved against the spring-loading in a direction (p) away from the male part (21′) for releasing the first connection element (3′) from the second connection element (3″). The locking sleeve (17) of the female part (23′) is associated with an operating device (29) for the said releasing.

### TECHNICAL FIELD

The present invention relates to a multiconnector for hoses or the like intended for media under pressure according to the preamble to claim 1. The media can be fluid, oil or gas.

The present invention is particularly suitable for the manufacturing industry for quick-release connectors but is not limited to this, also being able to be used within the construction industry, the vehicle industry, etc.

### BACKGROUND ART

Currently, various types of connector are known for connecting together high-pressure hoses. In particular, within the emergency services, connectors are used that can connect hoses between a pressure source and for example a tool, such as hydraulic cutters, etc, in a simple and safe way. Pressurized hydraulic oil flows in a first hose from the pressure source, such as a hydraulic pump, to the connector (the pressure side) and on to the tool, then back again (the return side) to the pressure source via the connector in a second hose. The advantage of so-called sexless connectors is that a user of, for example, emergency equipment, who needs to be able to connect hoses and tools together quickly, does not have to find matching connection ends, as all the connector parts are designed to be identical.

Connectors are also available where the first connection element comprises two male parts and the matching second connection element comprises two female parts, with the connection elements being able to be locked onto each other by means of a lever mechanism. When using known connectors, a user must shut off the pressure source before disconnecting the multiconnector. This shutting-off is time-consuming. The known connectors described above are also bulky.

In addition, such connectors require the user to disconnect the male part from the female part separately, which is also time-consuming.

The object of the present invention is also to achieve a multiconnector that makes it possible to connect hoses together safely and quickly, and avoids the disadvantages of known technology.

The object is also to make the manufacture and storage of multiconnectors more cost-effective.

The abovementioned problems have been solved by means of the multiconnector described in the introduction that has the properties described in the characterizing part of claim 1. Other objects and advantages of the invention are apparent from the associated subordinate claims.

In this way, a user can disconnect the multiconnector quickly and safely. The multiconnector is also cost-effective to manufacture.

The first connection element preferably comprises the second male part and the first female part, and the second connection element preferably comprises the first male part and the second female part.

Accordingly, the male part and the female part, forming a traditional first quick-release connector comprising a first locking sleeve arranged on the female part and a traditional second quick-release connector comprising a second locking sleeve, can be used to achieve a safe disconnection. If the multiconnector is dragged over an obstacle in a direction opposite to the direction that the first locking sleeve must be moved to release the male part from the female part, and the male part of the first quick-release connector is located in front of the female part viewed in the said releasing direction, and the obstacle has a tendency to catch on the locking sleeves, only the first locking sleeve will open the locking device of the first quick-release connector (provided that the force generated by the obstacle exceeds the spring-loading on the first locking sleeve). The second locking sleeve is not moved, as the direction for releasing it corresponds to the direction that the second locking sleeve must be moved in order to release the second quick-release connector. In this way, it is ensured that one of the quick-release connectors will remain in a locked position, depending upon the direction for release. Although its locking sleeve is moved for releasing the male part from the female part, the first quick-release connector will remain in the connected position as a result of the second quick-release connector, that is located alongside it, that remains locked. In addition to achieving a safe connection, the multiconnector means that a quick connection can be carried out, as a user can always find a connection element that is identical to another connection element when connecting hoses together. This also means that an unlimited length of hose can be utilized. At the same time, by means of a single action, a user can disconnect the multiconnector by simultaneously moving the operating device of both connection elements in a direction away from each other.

Alternatively, the operating device is a movable external sleeve that is arranged around the body of the rear part of the connection element.

By this means, an operating device has been achieved in a cost-effective way, with the spring-loaded locking sleeve being used to return the external sleeve to its original position. Similarly, the locking sleeve and ball catch of the respective female parts are used in an effective way to take up pressure forces in the multiconnector, and the external sleeve is used only for operating. The multiconnector also means that a low connecting force is required.

A hose protector is suitably arranged adjoining the connection element and is arranged around the hoses that are connected to the connection element.

In this way, a user can hold the hose protector instead of the hoses when connecting together the connection elements of the multiconnector.

A swivel connector is preferably mounted in association with the connection element and between this and the hoses.

This prevents the hoses from twisting and makes it easier to connect the multiconnector together.

Alternatively, through-flow ducts extend through the multiconnector to connection parts, at least one connecting duct connects together two through-flow ducts in a connection element, which connecting duct can be opened by means of a bypass valve device that can be operated by an operating device so that a medium can flow between the through-flow ducts.

Accordingly, in the connected position of the multiconnector, a medium can circulate from the pressure source in the pressure pipe to a tool. Thus, with the use of the multiconnector, it is not necessary for the pressure source to be shut off before disconnection of the multiconnector is carried out.

The operating device suitably consists of a nipple arrangement arranged on the male part and the bypass valve device is arranged in the female part in such a way that it can be moved for opening and closing the connecting duct.

Accordingly, the connecting movement in the longitudinal direction of the male and female parts can be used to control the opening of the connecting duct, as the bypass valve device can be moved in the said longitudinal direction along the centre line of the female part.

The bypass valve device preferably consists of a valve sleeve arranged in the female part for opening and closing the through-flow duct of the female part, the walls of the valve sleeve seal off the connecting duct when the through-flow duct is in the opened position, and the connecting duct is no longer sealed off by the wall of the valve sleeve when the through-flow duct is in the closed position.

Accordingly, the connecting movement in the longitudinal direction of the male and female parts can be used to control the opening of the connecting duct and a female part of a quick-release connector can be mounted on the body of the rear part, with the valve sleeve of the female part also being designed with through holes arranged transverse to the longitudinal direction of the female part to make an opening between the connecting duct and the through-flow ducts of the connection element in such a way that when the valve sleeve has sprung back and closes off the through-flow duct, the through hole of the valve sleeve is in line with the connecting duct, enabling a medium to flow from a first pipe (the pressure side) connected to the female part to the second pipe (the return side) connected to the male part or vice versa. The valve arrangement of the male part is also closed while disconnection is carried out. Accordingly, a tool can be disconnected/replaced without the hydraulic pump needing to be shut off.

Alternatively, the connection element has one female part and one male part.

In this way, the manufacture and storage of the multiconnector can be made more cost-effective, as the connection elements are all identical. Similarly, the pressure side and return side of the multiconnector can be freely selected which makes handling the multiconnector easier.

The connection element has suitably two female parts and two male parts. The multiconnector also enables loose female parts and male parts that are available on the market to be connected to it.

The present invention also relates to a hose package for emergency equipment, which hose package is arranged with the first and second connection elements, that are described above, on each end of the hose package.

### BRIEF DESCRIPTION OF DRAWINGS

In the following, the present invention will be described in greater detail with reference to associated drawings, in which:

FIG. 1 shows schematically a connection element according to a first embodiment of the present invention;

FIGS. 2a-2b show schematically two connection elements of the type shown in FIG. 1 comprising a multiconnector;

FIG. 3 shows schematically a cross section of a connection element;

FIGS. 4a-4c show schematically in cross section connection sequences of a multiconnector;

FIG. 5 shows schematically an enlargement and section of the cross section shown in FIG. 4c;

FIG. 6 shows schematically a second embodiment of the connection elements of the multiconnector in cross section;

FIG. 7 shows schematically a third embodiment of the multiconnector;

FIG. 8 shows schematically the multiconnector in use; and

FIGS. 9a-9d show schematically a multiconnector according to a fourth and a fifth embodiment.

### MODES FOR CARRYING OUT THE INVENTION

The present invention will now be described in the form of embodiments. For the sake of clarity, components that are not of significance for the invention have been omitted in the drawings. In certain cases, the same components that are shown in several figures are not given reference numerals, but correspond to those that have reference numerals.

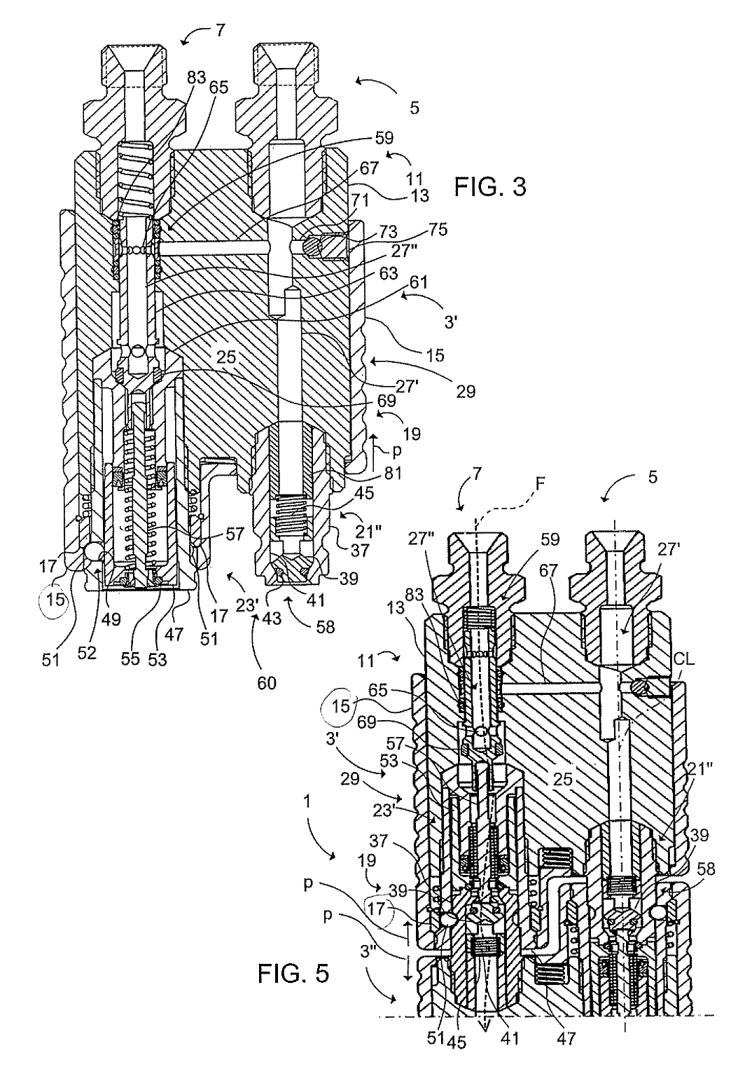

FIG. 1 shows a connection element 3 of a multiconnector 1 according to a first embodiment. The connection element 3 comprises a first and a second connection part 5, 7, that can be connected to high-pressure hoses 9 for media (such as hydraulic oil) under pressure. A back section 11 of the body of a rear part 13 is visible. A movable external sleeve 15 that is arranged around the body of the rear part 13 engages with a locking sleeve 17 (not visible, see FIG. 3) that is arranged internally in the front section 19 of the external sleeve 15. A male part 21 and a female part 23 of the connection element 3 are permanently attached to a front section 25 of the body of the rear part 13. Through-flow ducts 27′, 27″ (see FIG. 3) extend from and into the male and female parts 21, 23 respectively to the connection parts 5, 7 on the rear section 11 of the body of the rear part 13. The external sleeve 15 can be operated manually for releasing and disconnecting the connection element 3 from a second connection element. The external sleeve 15 serves as an operating device 29 for the said releasing.

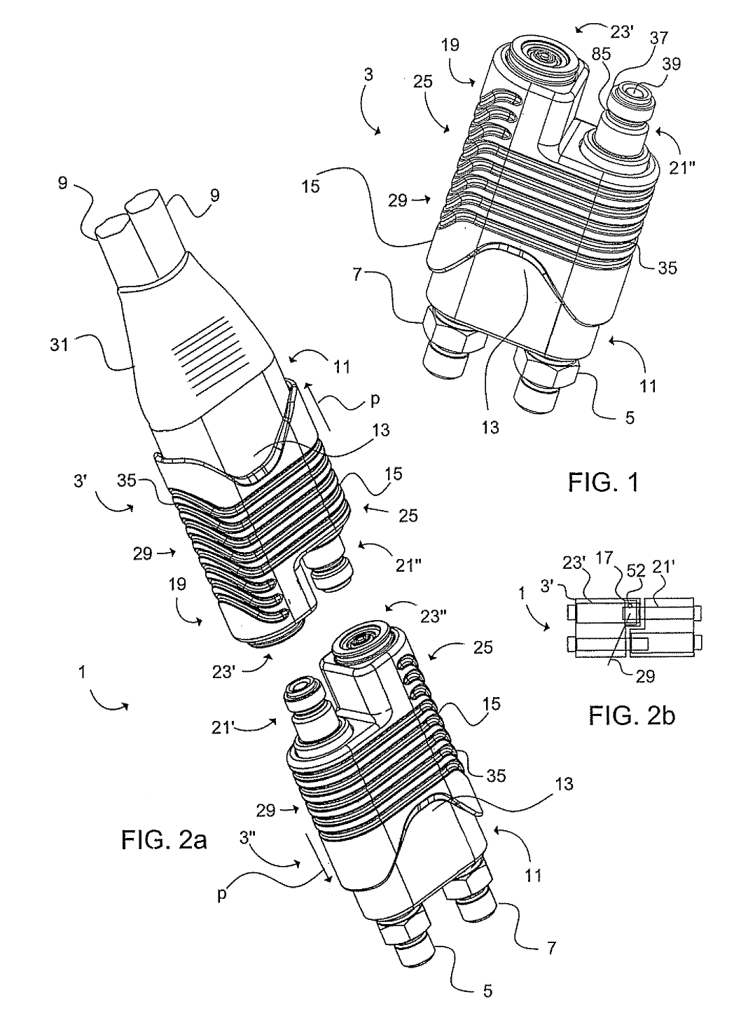

FIG. 2 shows a first and a second connection element 3′, 3″ comprising a multiconnector 1 according to the first embodiment. A hose protector 31 is arranged adjoining the connection element 3′ and is arranged around the ends 33 of the hoses 9 that are connected to the first and second connection parts 5, 7 of the connection element 3′. A first male part 21′ and a first female part 23′ are mounted in the first connection element 3′. A second male part 21″ and a second female part 23″ are mounted in the second connection element 3″.

In addition to the multiconnector 1 having a safety function in that both the external sleeves 15 must be moved simultaneously in a direction away from each other when the connection elements 3′, 3″ are connected together and are to be disconnected (it is thus not sufficient for only one external sleeve 15 to be moved backwards in the direction p), the multiconnector 1 also enables a connection to be made quickly, as a user, such as emergency personnel, can always find a connection element 3′, 3″ that is identical to another connection element when hoses are to be connected together. The hose protector 31 is arranged on the rear section 11 of the body of the rear part 13 around the ends 33 of the hoses, partly to protect the ends 33 of the hoses from deterioration due to bending, and partly to create a user-friendly hand grip 35. FIG. 2b shows schematically the construction of a multiconnector 1 comprising a locking sleeve that can be operated by an operating device 29.

FIG. 3 shows a cross section of the connection element 3 in the disconnected position. The connection element 3 comprises a first male part 21′ and a first female part 23′ essentially constructed of components that are to be found on quick-release connectors for high-pressure hydraulics. The working pressure can be 700 bar to 3000 bar. The connection element 3 can be connected to a so-called twin hose (not shown), consisting of two hoses 9—a pressure pipe and a return pipe—that are joined together, via the first and the second connection parts 5, 7.

The connection parts 5, 7 are mounted in the rear section 11 of the body of the rear part 13. The first male part 21′ and the first female part 23′ are mounted in the front section 25 of the body of the rear part 13. In the disassembled state, the first male part 21′ should fit into the first female part 23′. The first male part 21′ comprises a nipple body 37, in which a nipple valve 39 that can be moved inside this is arranged to form a seal (in the disconnected state of the multiconnector 1) against the inner wall 41 of the nipple body 37 by means of an O-ring 43. A spring 45 urges the nipple valve 39 to form a sealing engagement with the nipple body 37. A first through-flow duct 27′ extends from the first male part 21′ (the through-flow ducts 27′, 27″ also include through-flow ducts through the male and female parts 21, 23) to the first connection part 5. The first female part 23′ comprises a front part 47 with recess 49 for locking balls 51. A catch sleeve 53 is mounted in the front part 47 in such a way that it can be moved and is arranged to open a second through-flow duct 27″ between the first female part 23′ and the second connection part 7. An O-ring 55 is arranged to form a seal between a valve spindle 57 and the catch sleeve 53. The valve spindle 57 is arranged to be able to be moved inside the catch sleeve 53, which valve spindle 57 is arranged to operate a bypass valve device 59, such as a bypass valve 63 in which holes 65 are made, that is arranged to be able to be moved in the second through-flow duct 27″ and in the valve seat 61 of the first female part 23′.

In the disconnected state of the multiconnector 1, the bypass valve 63 is in such a position that the holes 65 are in line with a connecting duct 67 that connects together the respective through-flow ducts 27′, 27″. In the disconnected state of the multiconnector 1, a pressurized medium passing through the first connection part 5 (the pressure side) can thus continue via the connecting duct 67 and through the bypass valve 63 and onward back out through the second connection part 7 (the return side). The direction of flow can also be reversed. A sealing ring 69 forms a seal between the valve seat 61 and the bypass valve 63. In the disconnected position shown in FIG. 3, the bypass valve 63 is thus open and allows free passage of media from the pressure side directly to the return side, while at the same time the bypass valve 63 forms a seal against the valve seat 61. A through hole 71 for the connecting duct 67 between the pressure side and the return side is sealed against the outside by means of a ball 73 and a clamping screw 75.

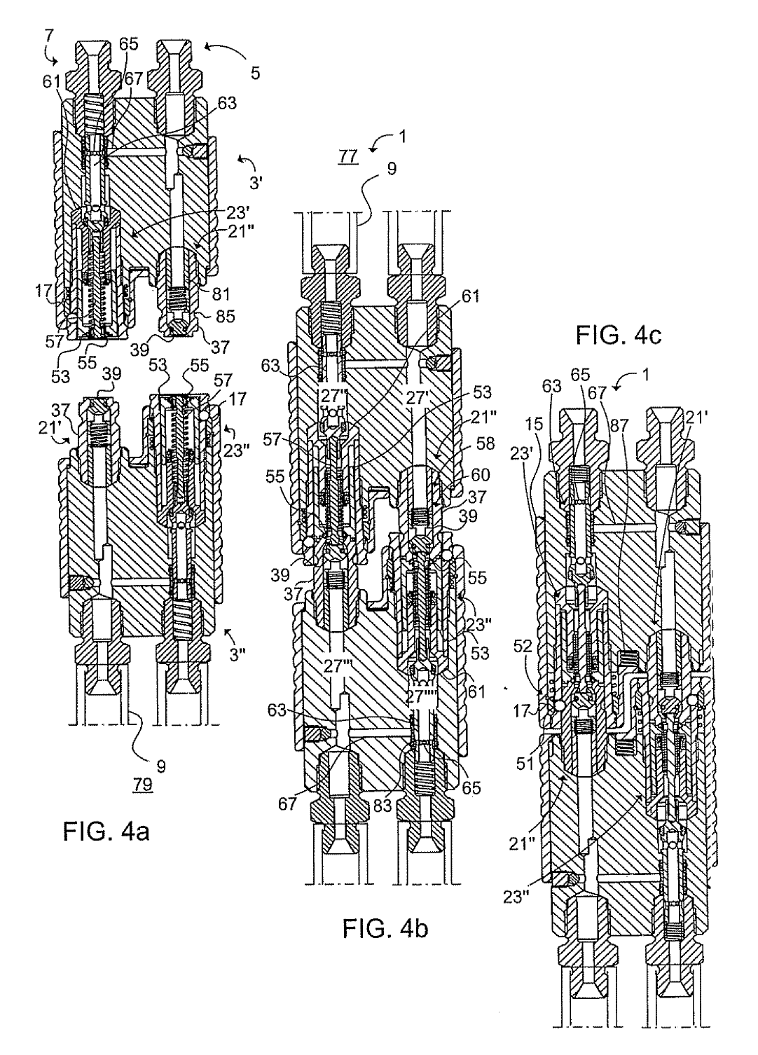

FIGS. 4a-4c show a multiconnector 1 in various connection stages. FIG. 4a shows the multiconnector 1 in the disconnected position. The first and second connection parts 5, 7 of the respective connection elements 3′, 3″ are connected to the respective combined pressure and return hoses 9 for pressurized fluid. The hoses 9 extend between a hydraulic pump 77 (see FIG. 8) and a tool 79, such as plate shears, bolt-tightening tool or dual-action hydraulic cylinder. In the disconnected state, the pressurized medium “flows in reverse” through one connection element 3′ (that, for example, is on the hydraulic pump side) via the bypass valve 63 from the pressure pipe to the return pipe, as described above. The pressure source or driving source, such as a hydraulic pump 77, can thereby be in operation even when the multiconnector 1 is disconnected. The second connection element 3″ in FIG. 4a for the tool side is thus not pressurized.

In the connecting sequence shown in FIG. 4b, the O-ring 55 on the catch sleeve 53 forms a seal between the catch sleeve 53 and the nipple body 37. The nipple valve 39 bottoms against a valve stop 81 arranged in the rear part of the nipple body 37. When the nipple valve 39 has bottomed, this nipple valve 39 comprised in a nipple arrangement 58 in the male part 21′, acting as an operating device 60, presses the valve spindle 57 of the matching female part 23″ in the second connection element 3″ a short distance so that the bypass valve 63 opens at the valve seat 61. The first and second through-flow ducts 27′, 27″ in the respective connection elements 3′, 3″ are now open for a through flow of a medium. In this position, the bypass valve 63 in the respective connection element 3′, 3″ has been moved so far that the holes 65 in the bypass valve 63 are outside the connecting duct 67 and start to be sealed off by means of seals 83. The connecting duct 67 is now closed.

When connection continues, the connection elements 3′, 3″ are locked together automatically by the locking balls 51 being pressed down into a groove 85 in the nipple body 37 into a locked position by means of the locking sleeve 17 on the respective female part 23′, 23″. Each locking sleeve 17 is spring-loaded in a direction towards the locked position, in which position the locking sleeve 17 holds the locking balls 51 (a so-called ball catch 52) in an engaged position for locking the respective male part 21′, 21″ in a connected position in the respective female part 23′, 23″. See FIG. 4c. For locking, the external sleeve 15 in turn moves the locking sleeve 17 by means of a spring 87 that is positioned centrally in the respective connection element 3′, 3″. The locking is thus carried out automatically when the two connection elements 3′, 3″ are connected together.

FIG. 4c shows the completed connection of the multiconnector 1. The multiconnector 1 is now locked by means of the locking balls 51 and the bypass valve 63 is closed in the respective connection elements 3′, 3″ and no flow is possible through the connecting duct 67 between the pressure side and the return side of the respective connection elements 3′, 3″. The first connection element 3′ comprises the first male part 21′ and the first female part 23′. The second connection element 3″ comprises the second male part 21″ and the second female part 23″. That is, the first male part 21′ fits into the second female part 23″ and the second male part 21″ fits into the first female part 23′.

When disconnecting, the external sleeves 15 on the respective connection elements 3′, 3″ are moved simultaneously in a direction away from each other, that is each external sleeve 15 moves the locking sleeve of the respective female part 23′, 23″ against the spring loading in a direction away from the male part 21′, 21″, to release the male part 21′, 21″ from the female part 23′, 23″. The respective nipple valve 39 is urged back by means of the spring 45 and forms a seal against the respective nipple body 37. The respective catch sleeve 53 and valve spindle 57 are urged back by means of a spring 89, whereby the bypass valve 63 forms a seal against the valve seat 61. At the same time, by means of this spring-back action, the bypass valve 63 opens a passage between the through-flow ducts 27′, 27″ and the connecting duct 67. Due to the fact that both the locking sleeves 17 must be operated simultaneously, accidental disconnection is prevented from occurring.

The connection elements 3′, 3″ described in FIGS. 4a-4c are identical and components and movements of the components are the same for both the connection elements 3′, 3″, even when the function of only one of the connection elements has been described.

FIG. 5 shows an enlargement and a section of the cross section of the multiconnector 1 in the connected position shown in FIG. 4c. This shows clearly the flow (broken line) through the multiconnector 1. The closed bypass valve 63 prevents a flow through the connecting duct 67. The external sleeve 15 can move in a direction parallel to the respective centre lines CL of the male and female parts 21, 23. The locking sleeve 17 of the female part 23 can also move in this direction.

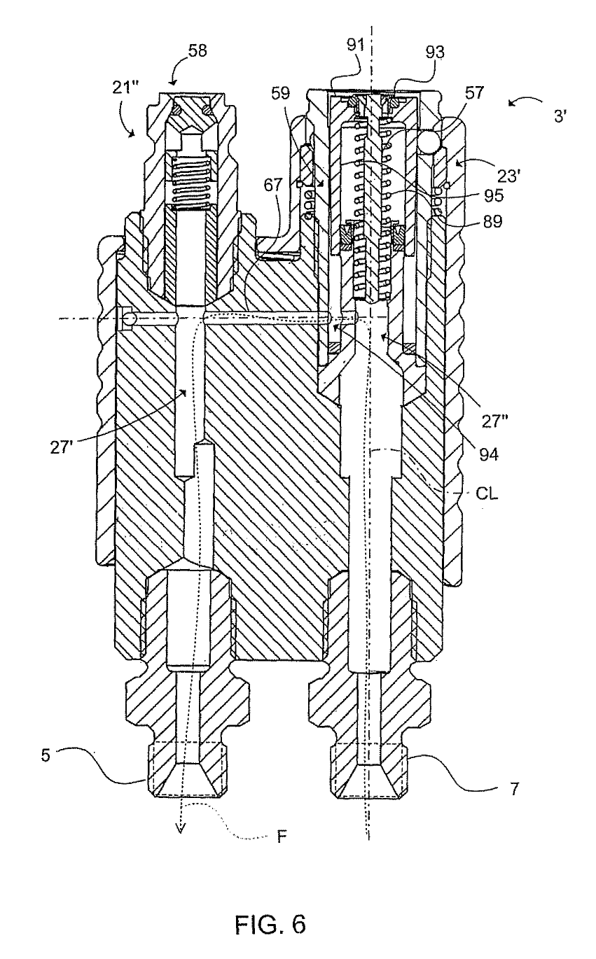

FIG. 6 shows schematically a connection element 3′ of a multiconnector 1 according to a second embodiment. According to this embodiment, the bypass valve device 59 consists of a valve sleeve 91 arranged in the female part 23, primarily intended for opening and closing the through-flow duct 27″ in the female part 23. When the valve sleeve 91 is moved in a direction inwards inside the female part 23 along the centre line CL, by means of the nipple body 37 in the inserted male part 21 of the second connection element, the through-flow duct 27 in the female part 23 is opened. When the valve sleeve 91 springs back by means of a spring 89 when disconnection is carried out, the valve sleeve 91 forms a seal by means of a seal 93 against the valve spindle 57 of the female part 23, whereby the through-flow duct 27 is closed. The wall 95 of the valve sleeve 91 is then alongside and opens the mouth 94 of the connecting duct 67 so that a medium can flow from the first through-flow duct 27′ to the second through-flow duct 27″ in the connection element 3′ or vice versa. Thus the wall 95 of the valve sleeve 91 closes off the connecting duct 67 when the through-flow ducts 27′, 27″ are in the opened position. The connecting duct 67 is not closed off by the wall 95 of the valve sleeve 91 when the through-flow ducts 27′, 27″ are in the closed position. When the valve sleeve 91 is moved inwards, the seal 93 on the valve sleeve 91 will move the valve spindle 57 away so that the through-flow duct 27 is opened, while at the same time the wall 95 of the valve sleeve 91 seals off the connecting duct 67 so that when the multiconnector 1 is in the connected position, a medium can flow from the hydraulic pump 77 via the multiconnector 1 to the tool 79 and back to the hydraulic pump 77 (see FIG. 8).

The described bypass function of the multiconnector 1 means that the hydraulic pump 77 does not need to be shut off, which makes quick and easy operation of the multiconnector 1 possible. Quick operation is also achieved as a result of each connection element 3′, 3″ being constructed of one male part 21 and one female part 23. A user does not need to find the correct hose end, which is the case when one hose end is arranged with two female parts and one hose end with two male parts.

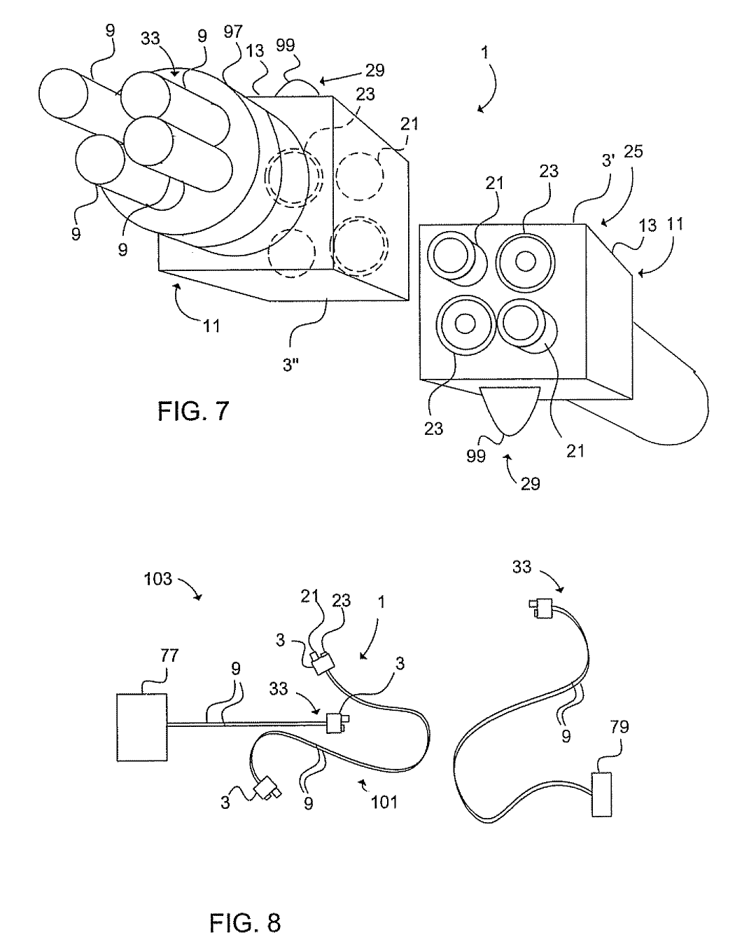

FIG. 7 shows schematically a third embodiment of the multiconnector 1. Each connection element 3′, 3″ comprises two male parts 21 and two female parts 23. The male parts 21 fit into the female parts 23. Four high-pressure hoses 9 are connected to the body of the rear part 13 of the connection element 3 via a swivel connector 97, that is mounted between the connection element 3″ and the hose ends 33. The swivel connector 97 means that rotation of the connection element 3″ can take place without the hoses 9 needing to be rotated. In this way, handling of the multiconnector 1 for connecting is simplified. Two male parts 21 and two female parts 23 of the connection elements 3′, 3″ are permanently mounted in a front section 25 of the body of the rear part 13. Through-flow ducts (not shown) extend through the body of the rear part 13 from and into the male and female parts 21, 23 respectively to connection parts (not shown) for the swivel connector 97 that are arranged on the rear section 11 of the body of the rear part 13. An operating device 29 in the form of a lug 99 is arranged on each body of the rear part 13 for disconnecting the multiconnector 1. The operating device 29 on each connection element 3′, 3″ is arranged to engage with the locking sleeves 17 of both the female parts 23 (not shown).

FIG. 8 shows schematically the multiconnector 1 when used with an item of emergency equipment 103. Two high-pressure hoses 9 are connected to a hydraulic pump 77, with a connection element 3 mounted on each end 33 of the hoses. A hose package 101, comprising two high-pressure hoses 9 with a connection element 3 on each end, is placed on the ground for connecting the hydraulic pump 77 to an emergency tool 79. Two high-pressure hoses 9 are connected to the emergency tool 79, and a connection element 3 is mounted on the ends 33 of the hoses.

Emergency personnel (not shown) can connect any end of the hose package 101 to the respective connection element 3 associated with the hydraulic pump/emergency tool 77, 79. The emergency personnel do not need to find the correct end, as the connection elements 3 are identical, which saves time.

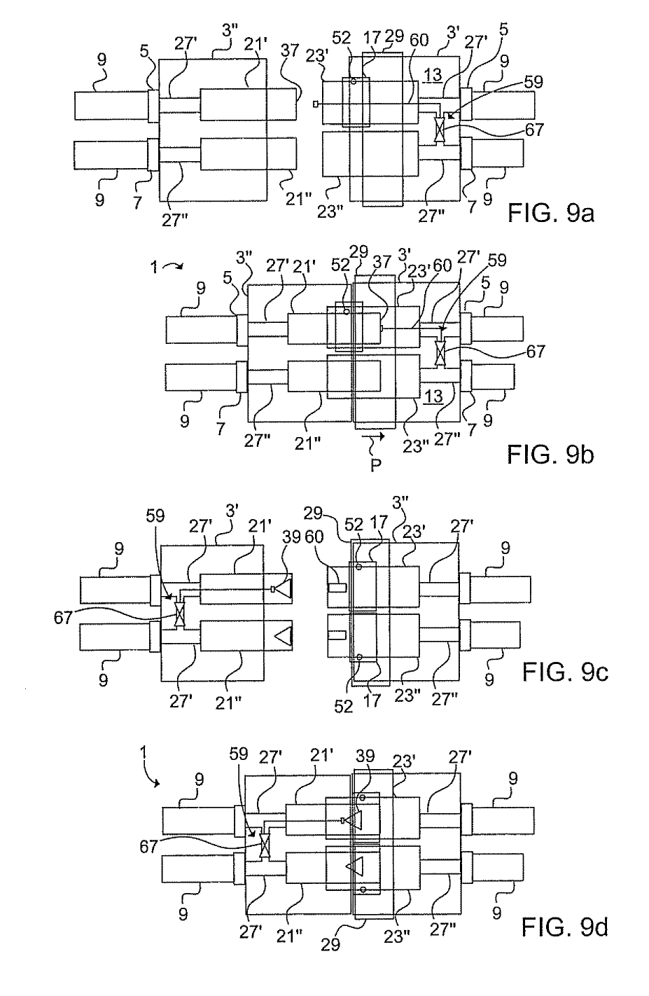

FIG. 9a shows schematically a fourth embodiment of the multiconnector 1. The first connection element 3′ comprises a first female part 23′ and a second female part 23″. The first female part 23′ is connected to the first connection part 5 via a first through-flow duct 27′. The second female part 23″ is connected to the second connection part 7 via a second through-flow duct 27″. An external sleeve forms an operating device 29 in engagement with the locking sleeve 17 of the first female part 23′. A connecting duct 67 connects the first through-flow duct 27′ to the second through-flow duct 27″. A bypass valve device 59 is arranged in the connecting duct to open and close the connecting duct between the first and the second through-flow ducts 27′, 27″. The bypass valve device 59 is connected in such a way that it is operated by an operating device 60 in the form of a lever. The operating device 60 is, in turn, acted upon by a first male part 21′ of the second connection element 3″ when connecting the multiconnector 1. The nipple bodies 37 and the valves of the female parts 23′, 23″ open after the connection, while at the same time the operating device 60 causes the operating valve device 59 to open between the first and the second through-flow ducts 27′, 27″. The completed connection is shown schematically in FIG. 9b.

A fifth embodiment is shown schematically in FIGS. 9c and 9d. According to this embodiment, the connecting duct 67 is arranged in a first connection element 3′ comprising the first and second male parts 21′, 21″. The first and second female parts arranged in the second connection element 3″ each comprise an operating device 60 for operating the nipple valves 39 on the male parts 21′, 21″ that in turn operate the respective bypass valve device 59.

The present invention is not to be regarded as being limited to the embodiments described above, modifications and combinations of these being possible within the framework of the present invention. For example, more male and female parts can be arranged in a connection element, for example six or eight. Alternatively, the bypass valve device can be arranged in the connecting duct where a seat valve is operated by the valves in the male and female parts for opening and closing of the connecting duct.

In addition, the operating devices could form an integrated handgrip device that disconnects the multiconnector and opens the bypass.

Male and female parts can be manufactured of hardened steel or of chromium-plated brass that resists corrosion and has a long life. The material of the O-rings can be nitrile rubber, viton, EPDM rubber, etc. Valve devices can be made of steel, brass, etc. The male parts and female parts can be mounted by means of locking washers, mechanical joints, etc. Spring elements can be compressible plastic springs or sleeves. Several connecting ducts can be arranged in the body of the rear part between the through-flow ducts. When their construction is identical, the connection elements are suitably provided with distinguishing colours in order to assist the user in connecting together the correct connection elements, for example if the return pipe and the pressure pipe have different characteristics and have different dimensions.

The bypass function can, of course, be arranged in both the first connection element and the second connection element in the multiconnector.

1-10. (canceled)

11. Multiconnector for hoses or the like for media under pressure, comprising a first and a second connection element, which multiconnector comprises first and second male parts and first and second female parts, one of the connection elements comprises a female part that comprises a locking sleeve that is spring-loaded towards a locked position, in which position the locking sleeve holds a ball catch in an engaged position for locking the male part in the female part in the connected position, the locking sleeve can be moved against the spring-loading in a direction away from the male part for releasing the first connection element from the second connection element, wherein the locking sleeve of the female part is associated with an operating device for the said releasing, by that the operating device is arranged in engagement with the locking sleeve and the first connection element comprises the second male part and the first female part, and the second connection element comprises the first male part and the second female part.

12. Multiconnector according to claim 11, wherein the operating device is a movable external sleeve arranged around the body of the rear part of the connection element.

13. Multiconnector according to claim 11, wherein a hose protector is arranged adjoining the connection element and is arranged around the hoses, that are connected to the connection element.

14. Multiconnector according to claim 11, wherein a swivel connector is mounted in association with the connection element and between this and the hoses.

15. Multiconnector according to claim 11, wherein through-flow ducts extend through the multiconnector to connection parts, at least one connecting duct connects together two through-flow ducts in a connection element, which connecting duct can be opened by means of a bypass valve device that is operated by an operating device so that a medium can flow between the through-flow ducts.

16. Multiconnector according to claim 15, wherein the operating device consists of a nipple arrangement arranged on the male part and the bypass valve device is arranged in the female part in such a way that it can be moved for opening and closing the connecting duct.

17. Multiconnector according to claim 15, wherein the bypass valve device consists of a valve sleeve arranged in the female part for opening and closing the through-flow duct in the female part, the wall of the valve sleeve seals off the connecting duct when the through-flow duct is in the open position, and the connecting duct is no longer sealed off by the wall of the valve sleeve when the through-flow duct is in the closed position.

18. Multiconnector according to claim 11, wherein the connection element has one male part and one female part.

19. Multiconnector according to claim 11, wherein the connection element has two female parts and two male parts.

20. Hose package for emergency equipment, wherein the hose package is arranged with a first and a second connection element, according to claim 11, at each end of the hose package.

21. Multiconnector according to claim 12, wherein a hose protector is arranged adjoining the connection element and is arranged around the hoses, that are connected to the connection element.

22. Multiconnector according to claim 12, wherein a swivel connector is mounted in association with the connection element and between this and the hoses.

23. Multiconnector according to claim 13, wherein a swivel connector is mounted in association with the connection element and between this and the hoses.

24. Multiconnector according to claim 12, wherein through-flow ducts extend through the multiconnector to connection parts, at least one connecting duct connects together two through-flow ducts in a connection element, which connecting duct can be opened by means of a bypass valve device that is operated by an operating device so that a medium can flow between the through-flow ducts.

25. Multiconnector according to claim 13, wherein through-flow ducts extend through the multiconnector to connection parts, at least one connecting duct connects together two through-flow ducts in a connection element, which connecting duct can be opened by means of a bypass valve device that is operated by an operating device so that a medium can flow between the through-flow ducts.

26. Multiconnector according to claim 14, wherein through-flow ducts extend through the multiconnector to connection parts, at least one connecting duct connects together two through-flow ducts in a connection element, which connecting duct can be opened by means of a bypass valve device that is operated by an operating device so that a medium can flow between the through-flow ducts.

27. Multiconnector according to claim 16, wherein the bypass valve device consists of a valve sleeve arranged in the female part for opening and closing the through-flow duct in the female part, the wall of the valve sleeve seals off the connecting duct when the through-flow duct is in the open position, and the connecting duct is no longer sealed off by the wall of the valve sleeve when the through-flow duct is in the closed position.

28. Multiconnector according to claim 12, wherein the connection element has one male part and one female part.

29. Multiconnector according to claim 13, wherein the connection element has one male part and one female part.

30. Multiconnector according to claim 14, wherein the connection element has one male part and one female part.
